(19) United States
(12) Patent Application Publication
(10) Pub. No.: US 2020/0182687 A1
(43) Pub. Date: Jun. 11, 2020

(54) DEVICE FOR MEASURING LIGHT EXPOSURE OF A SUBJECT

(71) Applicant: LYS Technologies Ltd, London (GB)

(72) Inventor: Christina Catharina Friis Blach Petersen, Aarhus (DK)

(21) Appl. No.: 16/637,392

(22) PCT Filed: Aug. 10, 2018
(86) PCT No.: PCT/EP2018/071816

§ 371 Date: Feb. 7, 2020

(30) Foreign Application Priority Data
Aug. 11, 2017 (EP) 17186054.7

(51) Int. Cl. G01J 1/02; G01J 1/04; G01J 1/32

(52) U.S. Cl. CPC G01J 1/0233; G01J 1/0422; G01J 1/32; G01J 1/0266; G01J 1/0403; G01J 1/0219

(57) ABSTRACT

A wearable device for measuring the light conditions of a subject includes a light sensor for measuring said light conditions, and a light guide for collecting incoming light and directing it to said light sensor. A software application is also provided executable on a remote device and configured for receiving data from the wearable device via a receiver on the remote device, processing the data by means of the remote device to provide data representing the light exposure of the subject wearing the wearable device, and displaying at least a part of the data on a screen of the remote device.

The present invention relates to a wearable device for measuring and managing the light conditions of a subject.

### BACKGROUND OF INVENTION

Life is dependent on circadian rhythms to ensure the best use of daylight hours and to promote rest in the darkness, which promotes repairing and renewing of cells and during which memory adjustments can be carried out for the next day.

On an overcast day in Europe, the intensity of natural light is around 10,000 lux, and may be as high as 100,000 lux on bright sunny days. Yet homes and work in offices, factories, schools and hospitals are often isolated from natural light and the artificial light in these places is often around 200 lux and seldom exceeds 400-500 lux

Light is the main reference of time for the circadian system and the eye is the only source of light information for our brain. The problem is that we grab light and we then forget that we received it, because the eye needs to form the vision. We therefore don't have a natural feedback mechanism to tell us whether we have received healthy light or not.

Circadian rhythms are found in nearly every living thing on the earth. They help organisms time their daily and seasonal activities so that they are synchronized to the external world and the predicted changes in the environment. Circadian rhythms are the roughly 24 hour cycles in the physiological processes of living beings, including humans. The circadian rhythm synchronizes the human body clock with the environmental light thanks to photoreceptors found in the retina in the back of the eye. The circadian rhythm is the body's reference of time and regulates many vital physiological processes. This means that light is directly responsible for the correct functioning of many physiological processes. In our urban environments, artificial light is omnipresent, monochromatic and constant in intensity and color. This combination is drastically different from the rhythms of light found in nature required by all living beings. Because of these behaviors and habits, most people receive the wrong combination of light at the wrong time of day. Our nights are excessively illuminated whereas our daytime is mainly spent in dim indoor environments. This confuses the circadian rhythm and results in sleep disruption, stress and depression.

During the day, the eye gathers light information mostly in the form of images of the external world, but the eye also gathers information about light values, particularly the intensity of light and the blue wavelengths of light that is important to the circadian rhythm. The retinas in the eyes contain photosensitive cells called rods and cones that contribute to the visual interpretation of the world. A third type of photosensitive cells is also found within the retina called the Intrinsically Photosensitive Retinal Ganglion Cells (pRGCs). They are sensitive to a range of blue light and control the ability of the body to go to sleep.

In the center of the brain is the pineal gland which is used for controlling the circadian rhythm. In the absence of light at short wavelengths, specifically blue light with wavelengths around 460 nm, the pineal gland starts to secrete melatonin. Melatonin is involved in the entrainment (synchronization) of the circadian rhythms including sleep-wake timing and blood pressure regulation among others. This also means that exposing the ganglion cells to intense light, particularly blue light, at the wrong time of the day lowers the production of melatonin and may lead to circadian rhythm disruption. Conversely, receiving too little light during the day also triggers this mechanism preparing the subject's body for sleep rather than for a day of activity.

Different means for reducing exposure to the wrong kind of light before going to sleep have been put forward, such as night shift mode on phones and computers, which decreases the blue light emitted by the device by changing the colors to warmer ones. However, it may still be difficult to assess how much light within the blue range is emitted from the screen, and other light sources may still cause circadian rhythm disruption.

The daily cycle of activity and sleep is dependent on the circadian rhythm. In the active phase, energy expenditure is higher and food and water are consumed and organs need to be prepared for the intake, processing and uptake of nutrients. The organs therefore need internal synchronization, which the clock can provide. During the sleep phase, most physical activity may be suspended, but during sleep many essential activities occur including cellular repair, the removal of toxins, and in the brain, memory consolidation and information processing. Disruption of these patterns, as happens with jet-lag or shift work, may lead to desynchronization of the circadian system and our ability to do the right thing at the right time is greatly impaired. Most people in modern urban societies spend most of their time indoor and are only exposed to small amounts of light during daytime hours. In the evening, we use a wide range of electronic devices that emit light from screens or monitors. This behavior leads to further disruption of the natural cycle.

The disruption of the natural daily light exposure affects our health and well-being. The short-term effects are sleep disruption, low mood and low energy. The long-term effects may be more serious including stress and depression. Such long-term disruption has even been connected with cancer, heart disease and diabetes for people doing shift work at night. It is therefore desired to have a means for measuring, monitoring and quantifying the light conditions that a subject is exposed to during the day in order to determine possible problems and suggest solutions for remedying such problems.

### SUMMARY OF INVENTION

The present disclosure relates to a wearable device for measuring the light conditions of a subject. In a first embodiment the device comprises a light sensor for measuring said light conditions and a light guide for collecting incoming light and directing it to said light sensor. The light guide is preferably configured for collecting light from a predefined direction with respect to the device, said predefined direction defined by polar angles in the range between −90° and 90° and azimuth angles in the range between −30° and 90°. In one embodiment the present disclosure is aimed at measuring the light exposure of a subject wearing the device, and thereby possibly measuring and quantifying the circadian rhythm of the subject.

Measuring and quantifying the light exposure of a subject during the day and night is useful for alleviating the problems mentioned earlier, such as sleep disruption and low mood and energy. Such measurements preferably indicate at which times during the day the subject is exposed to the right and wrong kinds of light. Preferably, the measurements indicate the levels of blue light exposure during the day and night. Thereby, the measurements may show if the subject is exposed to too low intensity of light during the day or excessive amounts of light in the evening shortly before going to sleep. Avoiding such light patterns will lead to improved health and increases the well-being of the subject.

The light conditions measured by the device may include intensity, e.g. measured in lux, and color composition such as wavelength, e.g. measured in nanometers, or the color temperature of the light, e.g. measured in Kelvin. The light conditions may also relate to the time of the exposure to the light and the duration of the exposure. In one embodiment the device is configured for measuring photopic lux and circadian illuminance of the subject.

The ganglion cells are present in a large part of the retina, and are therefore also exposed to light coming from a wide range of directions. The device should therefore preferably gather light from many directions for the measurements such that it resembles the way the light affects the retinal ganglion cells in the eyes. Thereby the device gives an accurate and realistic measure of the light that the eyes are exposed to during the day. Therefore, in one embodiment the device is constructed such that the light guide is configured for collecting light from substantially all directions within a hemisphere with respect to the device and direct said light to the light sensor. In one example, the device could be attached to the clothes of the subject and pointing forwards in the same direction as the subject would normally be looking. The light guide may then gather light from directions in a hemisphere in front of the subject and guide it towards the light sensor such that it resembles the light gathered by the eyes. Furthermore, the device should preferably gather the light efficiently such that the light guide and sensor provide a high total effectivity.

The ganglion cells in the eyes are more sensitive to light coming from the upper part of the vision, normally corresponding to light from above the horizon. Therefore, in another embodiment the light guide is configured for collecting light from primarily one quadrant, e.g. defined by a polar angle in the range between −90° and 90° and an azimuth angle in the range between 0° and 90°, and direct said light to the light sensor. In yet another embodiment the light guide is configured for collecting light from polar angles in the range between −60° and 60° and azimuth angles in the range between 0° and 60°, and direct said light to the light sensor. In another example, the device is again attached to the clothes of a subject and may be configured for gathering light from a quadrant in front of the subject and above the horizon. This may yield a more accurate measurement of the amount of light that the ganglion light cells are exposed to during the day.

The device is preferably wearable, such that it can be attached to the body, such as a bracelet, necklace or glasses, or it may be attached to the clothes by using a clip or pin. This provides an advantageous position for taking measurements of the light exposure of the subject wearing the device.

Another embodiment of the present invention relates to a wearable device for estimating the light conditions of a subject wearing the device. The device comprises a top surface, a light sensor located below the top surface for measuring said light conditions, and a light guide for collecting incoming light and directing it to said light sensor. Preferably the light guide protrudes through the top surface of the device such that it can collect light more efficiently. The light guide preferably comprises at least a transparent piece of material with a light collecting region located on the top surface of the transparent piece of material. The light collecting region is in one embodiment located above the light sensor such that light may be more efficiently directed to the sensor. The light collecting region is in one embodiment shaped like a polygon such as a triangle, square, pentagon or hexagon. In another embodiment the light collecting region is circular. The light collecting region is preferably shaped such that it efficiently directs incident light to the light sensor. Furthermore, the light collecting region is preferably shaped such that light from a wide range of directions is gathered and collected by the light collecting region and directed to the light guide. The region should gather light from a wide range of directions in order to more accurately mimic the light gathering of the human eye such that the light conditions of the subject are estimated more accurately. The top surface of the device is preferably oriented vertically when worn by the subject and such that the surface normal points straight ahead from the subject when the device is worn by the subject. The light guide is preferably configured for collecting a substantial part of the light incident on the light guide from polar angles between −90° and 90° and azimuthal angles between −90° and 90°. In another embodiment the light guide is configured for collecting a substantial part of the light incident on the light guide from polar angles between −60° and 60° and azimuthal angles between −60° and 60°, or from polar angles between −40° and 40° and azimuthal angles between −40° and 40°, or from polar angles between −30° and 30° and azimuthal angles between −30° and 30°. A substantial part of the light may here refer to at least 20%, or at least 30%, or at least 40%, or at least 50%, or at least 60%, or at least 80% of the light incident on the light guide within the specified range of directions. The light measured may be in the visible range, i.e. 400-700 nm wavelength, or it may additionally extend into the ultraviolet and/or infrared range.

### DESCRIPTION OF DRAWINGS

FIG. 1 shows one embodiment of the invention, where the device consists of a housing with the logo protruding trough the top of the housing and a clip on the back of the housing.

FIG. 2 shows one embodiment of the invention where the device is attached to the clothes of the user.

FIG. 3 is a visual representation of a calculation of how one embodiment of the light guide collects light as a function of the angle of the incoming light.

FIG. 4 shows the result of the calculation illustrated in FIG. 3. This embodiment of the light guide mainly gathers light from polar angles in the range from −90° to 90° and azimuth angles in the range from −40° to 90°.

FIG. 5 shows a perspective view of the light guide and a support section for the light guide as used in the embodiment shown in FIG. 1.

FIG. 6 shows a top view of the light guide and a support section for the light guide as used in the embodiment shown in FIG. 1.

FIG. 7 shows a side view of the light guide and a support section for the light guide as used in the embodiment shown in FIG. 1.

FIG. 8 shows another a side view of the light guide and a support section for the light guide as used in the embodiment shown in FIG. 1. The figure shows a cross-sectional view of the light guide.

FIGS. 9-15 show different embodiments of the light guide. These embodiments also comprise a circular light collecting region on top the top surface of the light guide. The circular light collecting region is different for each figure. The shape of the circular light collecting region may be used to tailor and customize the light collection properties of the light guide. FIG. 16 shows a slightly modified version of the light guide shown in FIGS. 5 and 6.

FIG. 17 shows an embodiment of the device with a different logo worn by a user.

### DETAILED DESCRIPTION OF THE INVENTION

The present disclosure relates to a wearable device for collecting and measuring the light exposure of a subject. A first aspect of the invention is constructed such that a light guide gathers incoming light and guides it to a light sensor. The light guide may have a wide variety of shapes for directing the light to the sensor. The device is preferably constructed such that the peak sensitivity of the device is in the correct direction and such that the light is gathered efficiently. In one embodiment, this is achieved by having at least part of the outer surface of the light guide exposed to incoming light in the shape of a sphere or part of a sphere, such as a hemisphere. The shape of the outer surface of the light guide may also be ellipsoidal, or form part of an ellipsoid, or it could be a polyhedron, or part of a polyhedron. Other shapes that may be suitable for the outer surface of the light guide include planar, paraboloidal, cylindrical, conical, cosine shape, a plurality of planar faces, and in the shape of a prism. Alternatively, the outer surface of the light guide could be a combination of one or more of the shapes mentioned earlier. Shaping the light guide according to the aforementioned may enable the device to efficiently gather light from the right directions.

The device and light guide are preferably configured to collect light in a manner that resembles the light gathering of the human eye. Therefore, the light guide preferably collects light from a wide range of directions. Furthermore, the device may be configured for detecting non-visual effects of the light hitting the retina. Here, non-visual should not be understood as light not visible to the eye, but rather to light affecting other aspects of the human than the vision. This may for example be the ganglion cells and may be related to the production of melatonin. In one embodiment non-visual effects are related to light affecting the circadian rhythm of the subject. Detecting such non-visual effects can be achieved through the hardware of the device by using an appropriate sensor for detecting the non-visual effects. It may also be achieved through software by analyzing and/or processing the measurements from the sensor.

The light guide is preferably located in the device in a way that gives it direct access to the light of the surrounding environment. In one embodiment of the invention the light guide is located on the outer surface of the device. The light guide is then located in a position that easily allows for gathering the ambient light. In another embodiment the device further comprises a housing that contains the different parts for the device. The light guide may then be part of or integrated into said housing or at least part of the light guide may protrude through said housing or the light guide may be mounted on the outer surface of the housing. The light guide could be mounted on the outer surface of the housing or the light guide could be partly or entirely integrated into the housing. In another embodiment the light guide could at least partly protrude through the housing for gathering light which is then directed to the sensor located inside the housing.

The contour or outline of the light guide may be shaped in various ways. In one embodiment the light guide is shaped like a circle, or an ellipse, or a ring, or a triangle, or a square or any other polygon, or shaped like one or more letters or a part of one or more letters, or one or more symbols, or shaped like a logo, or an image or any combination thereof. As an example, the light guide could be shaped like one or more recognizable symbols or letters or form at least part of one or more recognizable symbols or letters located at the surface of the device. The light guide could also be shaped as part of any of the aforementioned shapes. Furthermore, the mentioned symbol(s), letter(s) or shapes may also protrude from the surface of the device. Having the light guide shaped as a logo or letters may be advantageous for quickly identifying the device and associating it with the present invention and it may contribute to the aesthetics and design of the device. It may furthermore assist in determining the orientation of the device such that the user can easily place the device in the right orientation. This may be relevant for the case where the device is more sensitive in some directions than others. The device should then be in the right orientation in order to gather light as intended. Integrating the light guide as part of text or a logo means that it becomes a seamless and unnoticed part of the device, which at the same time provides a means for determining the orientation of the device.

The size of the optical guide influences the amount of light picked up by the device. A bigger light guide will gather more light and may make the device more sensitive. On the other hand, a large light guide makes the device bigger and heavier. Therefore, in one embodiment of the invention the size of the light-gathering part of the light guide along its longest direction is less than 20 mm, or less than 15 mm, or less than 10 mm, or less than 7 mm, or less than 5 mm. In another embodiment the size of the light-gathering part of the light guide along its longest direction is at least 4 mm, or at least 6 mm, or at least 8 mm, or at least 10 mm, or at least 12 mm, or at least 16 mm, or at least 20 mm.

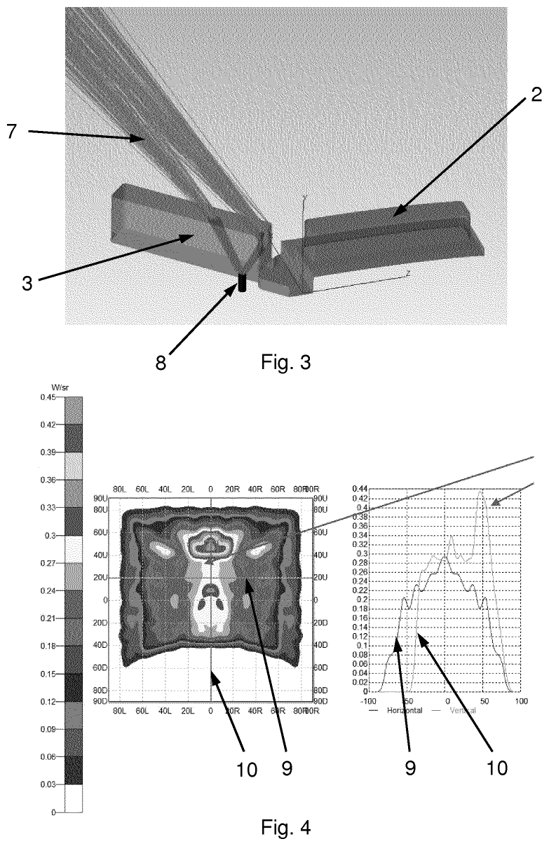

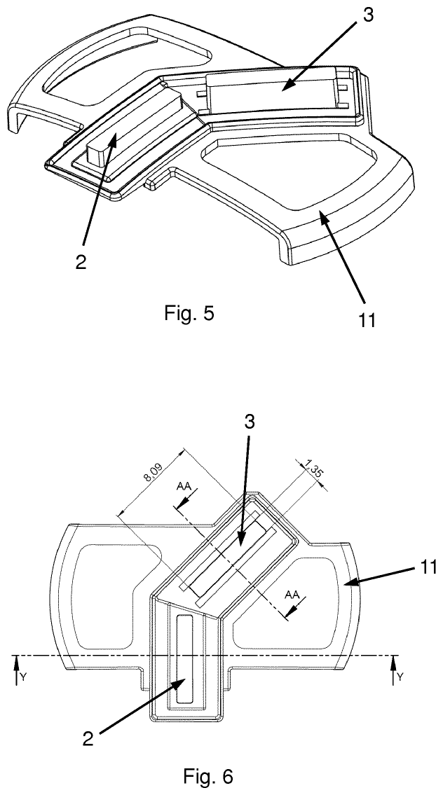

In another embodiment of the invention at least part of the outer surface of the light guide is shaped substantially as a rectangular prism. The prism may protrude through the top of the device for gathering incoming light. A light guide in the form of a rectangular prism may be suited for an aesthetic part of writing on the device. In one embodiment the light guide is constructed such that it constitutes at least part of the letter “Y” or at least part of a logo resembling a “Y, e.g. the lower straight portion or one of the upper straight portions. Specifically, the light guide may be a piece of material with planar faces forming right angles. The top face may protrude through the housing of the device, thereby serving as the main part of the light guide for gathering light. The light guide may in one embodiment have a width of 1.35 mm, a length of 8.09 mm and a thickness of 2.95 mm. The top face of the device may be rough or uneven for gathering the light in a more diffuse manner, and the bottom face of the light guide, meaning the face inside the housing, may have a more reflective internal surface except where the sensor gathers light. In another embodiment, two of the side faces (which in one embodiment measure 8.09 mm by 2.95 mm) form angles of 91.5° with the top face and angles of 91.85° and 91.87° with the bottom face. The side faces will then have a bend or curve. This specific embodiment of the light guide is depicted in FIG. 3 and FIGS. 5-8. Calculations as seen in FIG. 4 have shown that this shape for the light guide will gather light from primarily one quadrant and direct it to the light sensor. Thereby, the influence of the light exposure to the ganglion cells is measured accurately.

The light guide is preferably made from a material with a high refractive index. Therefore, in one embodiment the light guide is made from a plastic material such as acrylic glass (PMMA). Alternatively, the light guide may be made from regular glass. Other transparent materials may also be suited for the light guide.

The shape and dimensions of the device are preferably such that the device can be worn discretely. This could further make the user more inclined to using the device when it is discrete and not distinctive on the user. In one embodiment the device is flat with a thickness less than 20 mm, or less than 14 mm, or less than 11 mm, or less than 9 mm, or less than 7 mm, or less than 5 mm, or less than 3 mm. In another embodiment the device is circular or substantially circular, which may thereby form a disk shape, and the diameter of the device is less than 50 mm, or less than 40 mm, or less than 30 mm, or less than 25 mm, or less than 20 mm.

The light guide should preferably gather light from a wide range of directions, such as a hemisphere or quadrant, in order to accurately resemble the light gathered by the eye. The light-gathering sensitivity is preferably a smooth function of the polar and azimuth angles. Therefore, in one embodiment of the invention the surface of the light guide is rough or uneven or textured. This may diffuse the light as it hits the outer surface of the light guide and provide a smoother light-sensitivity of the device as a function of the polar and azimuth angles.

The light gathered by the light guide is directed to the light sensor which measures the intensity and color of the light and/or measures the illuminance as perceived by the human eye. In one embodiment of the invention the sensor is configured for measuring the intensity and/or illuminance and/or color temperature of the light. The device could for example be configured for measuring the intensity or illuminance measured in lux in the range 0-150,000 lux. The sensor may be calibrated in terms of both photopic lux and circadian illuminance. Alternatively, the device may also be configured for measuring infrared light. The sensor could be configured for measuring the light intensity throughout the visible spectrum, e.g. in the range 400-700 nm. In another embodiment the sensor is configured for measuring the light intensity of blue light. In yet another embodiment the sensor is configured for measuring light with wavelengths in the range 440-470 nm. Measuring the blue wavelengths of the light may be valuable for interpreting light as a stimulus to the circadian system and for quantifying circadian rhythm disruption and circadian stimulus, as the retinal ganglion cells and the pineal gland respond to this type of light, and the production of melatonin is thereby affected by this. The sensor may also be configured for measuring the light intensity for selected spectral regions, such as red, green and blue. In one embodiment the light sensor is the TCS3472 color light-to-digital converter. The intensity as well as the composition of the light may then be measured and used for evaluating the light that the subject is exposed to throughout the day. In yet another embodiment the sensor is configured for measuring the light intensity throughout the visible spectrum. Thereby, the intensity as a function of wavelength is known and the blue region, e.g. 440-470 nm wavelength, as well as the composition of the light may be evaluated.

The device is preferably configured for measuring at least four parameters; intensity, color, timing and duration. The intensity refers to the intensity of the light incident on the device, which is measured e.g. in lux. The color may refer to the actual color of the light or to the spectrum of the light or the spectral distribution of the light. Timing refers to the time of the day that the subject was exposed to a given light condition and duration refers to how much time subject was exposed to the light condition. One or more of these parameters, preferably all four parameters, are used in the present device to monitor the light exposure of the subject. This will provide a more realistic image of which kinds of light the subject is exposed to and for how long.

In one embodiment of the invention the light guide further comprises a light collecting region on the top surface of the light guide. The light collecting region is preferably shaped such that it efficiently collects light from a wide range of directions. The light collecting region is in one embodiment shaped like a polygon such as a triangle, square, pentagon or hexagon. In another embodiment the light collecting region is spherical or forms part of a sphere, or ellipsoidal or forms part of an ellipsoid, or a polyhedron or forms part of a polyhedron, or a dodecahedron or forms part of a dodecahedron, or an icosahedron or forms part of an icosahedron, or paraboloidal, or a plurality of planar faces, or cylindrical, or conical, or in the shape of a prism, or any combination thereof. The light collecting region may also be planar. In yet another embodiment the light collecting region is a biconvex lens, a hemispherical lens, a truncated cone, a parabolic shape, a plano-concave shape or a plano-convex shape. The shape of light collecting region may begin at the top surface of the light guide or it may be raised from the surface such that the shape, e.g. a hemisphere, begins at a raised point from the surface. The size of the light collecting region may be the full width of the light guide or it may be smaller than the width or the light guide, such as 90%, or 80%, or 70%, or 60%, or 50% of the width of the light guide.

In one embodiment the device comprises more than one sensor, such as two, three four or five sensors, to determine the light conditions. The sensors may be identical or different. Each sensor may be equipped with its own light guide. In an embodiment with multiple identical sensors, the sensors may be oriented in different directions such that they detect light from a wider range of directions. Each sensor may optionally cover a narrower range of directions than the total range of directions that the light is being gathered within. In another embodiment the device comprises a multi-spectral sensor. This multi-spectral sensor is in one embodiment configured for measuring wavelengths in the interval 200 nm to 1200 nm. One or more of the sensors can also be a simpler RGB sensor which brings the advantage of being much cheaper than spectrometers. The device may further comprise a temperature sensor for monitoring the skin temperature of the user. In another embodiment the device also comprise a GPS receiver to locate and the user and track the position of the user which can be correlated with the light conditions measurement. In yet another embodiment the device further comprises an IR-sensor and/or a UV sensor, which may be useful for determining if the light originates from an artificial light source or a natural light source.

The device is preferably worn by the user in a manner which allows the device to accurately measure the light exposure of the user. In one embodiment the device is part of or attachable to an earring, a clip, a brooch, a bracelet, a necklace, a ring, a watch, a belt buckle, a name tag, an eyeglass or an eyeglass frame. This means that the device is easily carried in a manner that is unnoticed by the user. Wearing the device on a name tag may be useful for some situations such as nurses and other personnel at a hospital or care homes, as well as patients at hospitals or care homes. In another embodiment the device further comprises a fastening element, such as a clip or a pin or a safety pin, for attaching the device to the clothes of the subject, such as a shirt, a collar, a pocket, a belt, a hat or other headgear, a shoe, a pair of pants, a jacket, a headband or sweatband, or for attaching the device to a bag or a backpack, or a strap of a bag or a backpack. This way the device may be worn in a discrete fashion, yet positioned to accurately measure the light exposure of the subject during the day. Alternatively, the device is attached to an object, such as a bag or backpack as mentioned earlier, or a purse, or to a phone or wallet. The device could also be mounted on an object at a desk and thereby measure the light exposure during work without the user having to carry the device.

In case the device is more sensitive to light from some directions than others, it should be in the right orientation when measuring the light exposure. In one embodiment, the clip may be rotatable, such that the housing may be rotated relative to the clip when mounted on e.g. the clothes of the user. In another embodiment part of the housing, such as the top half, is rotatable relative to another part of the housing, such as the bottom half.

The present invention is advantageous for measuring and monitoring the daily light exposure in any situation. However, the invention is also useful for situations where a person feels any symptom pointing to circadian rhythm disruption. The device may therefore also be used in a clinical context to measure and monitor the light exposure of a patient or for other clinical situations or as part of a medical device and clinical trial and tested device. The device could also apply to measuring the light exposure of patients that are admitted to a hospital or at a care home. The invention could also be used for children, such that their exposure to light from e.g. usage of phones, tablets and computers may be monitored by parents and/or care takers. Likewise, the device can be used to make sure elderly maintains a healthy circadian rhythm and may be monitored by family or care takers.

The device needs power from a source in order to function and collect data on the light exposure during the day. In one embodiment, the device further comprises a power source for powering the device. In a specific embodiment the power source comprises a battery. The battery is preferably a rechargeable battery, for example a lithium ion battery, such that the device may be recharged. The device may also have a charging base that allows users to measure light conditions while sleeping by placing the device in the charger. The device also preferably comprise a computer readable medium for storing said measured light conditions of users. The storing of the measurements could also be cloud based. The computer readable medium may be used for storing the measured data until the data is transferred to another device, such as a computer or a smartphone.

The data collected by the device is preferably transferred to another device in order for the data to be analyzed and/or displayed. Therefore, in one embodiment the device further comprises a wireless communication module for communicating wirelessly with another device, such as a phone. This wireless communication module may be a Bluetooth module, a WiFi module or infrared communication. Alternatively, the data may be transferred to another device using a communication cable between the two devices.

The device is preferably configured for measuring the light conditions at regular intervals, such as every 5 minutes, or every 2 minutes, or every 1 minute, or every 30 seconds, or every 20 seconds, or every 15 seconds, or every 10 seconds, or every 5 seconds. Thereby the device will record the light exposure during the entire day and provide sufficient data for analyzing the light exposure. This setting may in one embodiment be selected by the user. Selecting short intervals will provide more data, whereas selecting longer intervals may prolong battery life of the device. Sampling or measuring the light conditions often gives a more realistic and accurate measurement of the light conditions for the user as the measurement is not based on one instance, which could be very different from the actual conditions, but instead provides more data such that one unfortunate measurement not corresponding to the actual light conditions does not affect the analysis significantly. The device may also be configured for averaging measurements over an interval to obtain one measurement for that interval. This may for example be by averaging measurements every 15 seconds over a 10 minute interval to obtain one measurement for that interval. This will also reduce the amount of data necessary to store and transfer. If not connected to e.g. a smartphone, the device is configured for saving measurements in the device until a connection is established at which point the measurements may be transferred.

In one embodiment, the device further comprises an accelerometer for measuring the activity of the subject. This can also be useful for registering the movement of the subject during the day and for registering the position and orientation of the device. An accelerometer may furthermore be used for registering the movement of the subject during sleep, which may indicate the sleep quality of the subject.

The present disclosure relates to a device for measuring the light exposure of a subject. This device is preferably accompanied by a software application for analyzing and visually representing the data. Therefore, in one embodiment the invention further comprises a software application executable on a remote device and configured for receiving data from the device via a receiver on the remote device, processing said data by means of the remote device to provide data representing the light exposure of the subject wearing the device, and displaying at least a part of said data on a screen of the remote device. Examples of the remote device include a computer, a tablet and a smartphone. The analysis is preferably dependent on the person wearing the device, such that the personal characteristics are taken into consideration for the analysis. Therefore, in another embodiment the software application is further configured for receiving inputs characterizing the subject, such as age, gender, location and chronotype. The application may furthermore be configured for using previous light history of the user.

In another embodiment the device may be configured for sensing the orientation of the device and notify the user, either directly or through the software application, in case the device is in a wrong orientation. This may be accomplished using an accelerometer in the device. Such a feature may be useful for cases where the device is more sensitive to light from some directions than others.

The software application is preferably configured for displaying the analyzed light data in a clear manner that is easily understood. The software should give feedback that helps users improve their habits in order to receive healthier light at the right time of the day. This may be achieved by allowing users to compare their light intake over time with a recommended light cycle and the light cycle of nature and by giving actionable feedback and advice based on data and characteristics of the user. Thereby, users may entrain their circadian rhythm and understand what light helps them stay active and alert during the day and what light helps them prepare for sleep in the evening. In one embodiment the software application is further configured for displaying a now-function showing and/or analyzing the light exposure in real-time and/or a day-function showing and/or analyzing the light exposure throughout one day and/or a week-function showing and/or analyzing the light exposure during a week. The device may further have a night-function showing data during the night with a focus on 2-3 hours before bedtime. Such features will aid the user in identifying possible problems causing sleep disruption or otherwise affecting the circadian rhythm. It is important for the circadian rhythm that the subject is exposed to bright light (e.g. at least 1500 lux) in the first part of the day. Furthermore, it is important to reduce the exposure to blue light (440-470 nm) during the evening before going to bed. In another embodiment it is therefore another purpose of the application to provide a feature indicating the amount of time and duration with intense light in the first part of the day. This could for example be that the subject should be exposed to at least 30 minutes of light with an intensity of at least 1500 lux. Likewise, the application may provide a feature indicating the amount of time without blue light during the evening. This could for example be 2-3 hours with no or little amounts of blue light before going to bed.

In one embodiment of the invention the software application is further configured for comparing the data to a predefined range and notifying the user when light levels are outside said predefined range. This predefined range may as an example resemble the average natural light rhythm of the day. This feature may help the user receive a healthy light composition at the right time of the day. In another embodiment the software application is further configured for receiving input from the user indicating emotional or physical feeling such as mood and/or energy level and/or tiredness. This may be used to improve the application such that it can adjust a suggested light exposure according to the feedback and needs of the user. The application may further be set up to notify the user during a circadian reset phase and/or a light avoidance phase if the light exposure deviates from the recommended values for the phase. The circadian reset phase is defined as time immediately after the user wakes up. During this phase the user should be exposed to intense light, and the application may be set up to notify the user if the light intensity is too low. The light avoidance phase is defined as the lime before going to sleep, such as the last 2 hours or 3 hours before going to sleep. During this phase the user should avoid intense light, and the application may be set up to notify the user if the light is too intense.

The device and/or application may also use machine learning to adapt to new or current users based on data from other users. In one embodiment this may be achieved by supplying users with questions and correlate the answers with the measured light conditions for this user. These questions may be supplied on a regular basis or they may be supplied in the beginning after the user stars using the device.

These questions and answers from the users will make a more thorough and accurate model for the needs and recommendations for a user according to factors such as age, gender and chronotype.

The present invention may also communicate with other items in order to adjust the artificial lighting in the surrounding environment such that it suits the needs and requirements of the user wearing the device. This may apply to any lighting system such as home lighting or office lighting. In one embodiment the device is configured for communicating with a vehicle such that the lighting in the vehicle may be adjusted according to the measurements from the device and/or the characteristics of the subject, such as age, gender and chronotype, and/or the need of the subject wearing the device. The software application may also be configured for communicating with other items and/or a vehicle in order to adjust the surrounding lighting according to the needs of the user wearing the device.

The system may also be set up as a centralized system and/or application configured to collect data from multiple devices. This could for instance be useful for a care home or a hospice or for other situations where the users do not have a personal device for connecting to the device.

### DETAILED DESCRIPTION OF THE DRAWINGS

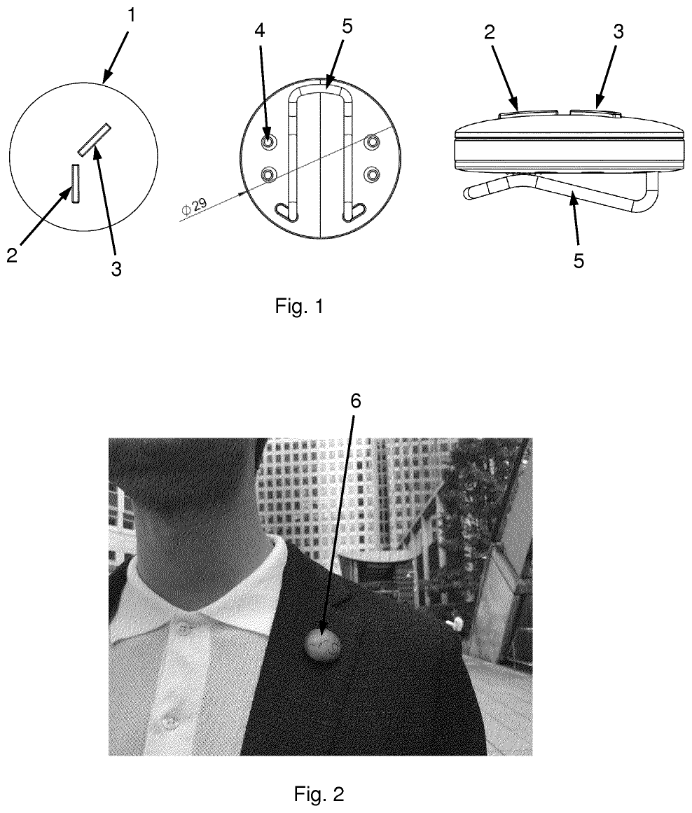

FIG. 1 shows top, bottom and side views of one embodiment of the invention, where the device consists of a housing 1 with the logo consisting of two parts 2,3 resembling a “Y” protruding trough the top of the housing. The two parts of the logo are a passive part 2 and the light guide part 3. On the back side are electrical contacts 4 that establish an electrical connection with a charging station when the device is placed in the charging station. Thereby, the device is recharged when it is in the charging station. Attached to the back is a clip 5 for attaching the device to for example a piece of clothes. The clip may in one embodiment be at least partly flexible such that it allows attachment to clothes or other items with a variety of thicknesses. Alternatively, the clip could be replaced by a pin. A light sensor is located inside the housing which measures the light from the light guide.

FIG. 2 is an image of one embodiment of the invention where the device 6 is attached the clothes of the user. The device may be attached using a clip or a pin on the back of the device. A position as shown in the figure may be advantageous for accurately measuring the light exposure, as the device is located fairly close to the eyes and pointing in the same direction as the user is facing.

FIG. 3 shows one embodiment of the logo 2,3 including the light guide 3 where a visual representation of a calculation of how the light guide 3 gathers light and directs it to the sensor is illustrated. Specifically the dependence on the incident angle of the incoming light is calculated. The figure shows numerous light rays 7 incident on the light guide 3 and directed to the sensor. The location 8 of the sensor is also indicated.

FIG. 4 is the result of the calculation illustrated in FIG. 3. The left part shows the sensitivity as function of the polar and azimuth angles. This embodiment primarily gathers light from polar angles in the range from −90° to 90° and azimuth angles in the range from −40° to 90°. The right part shows the sensitivity at the horizontal 9 and vertical 10 lines marked in the left part.

FIG. 5 shows a perspective view of one embodiment of the light guide 3, the other part of the logo 2 and a support section 11 for the parts for the logo 2,3. This embodiment may be suited for the device shown in FIG. 1. The light guide could also consist of the other part of the logo or consist of both parts of the logo, or the light guide could have an entirely different shape.

FIG. 6 shows a top view of the parts illustrated in FIG. 5. The measurements in mm for this specific embodiment of the light guide 3 are indicated in the figure.

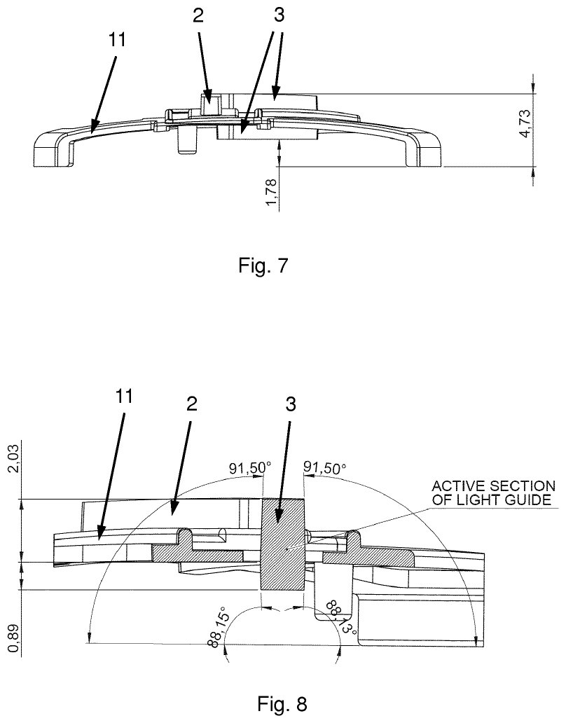

FIG. 7 shows a side view of the parts illustrated in FIG. 5.

FIG. 8 shows another side view of the parts illustrated in FIG. 5. The figure shows a cross-sectional view of the light guide.

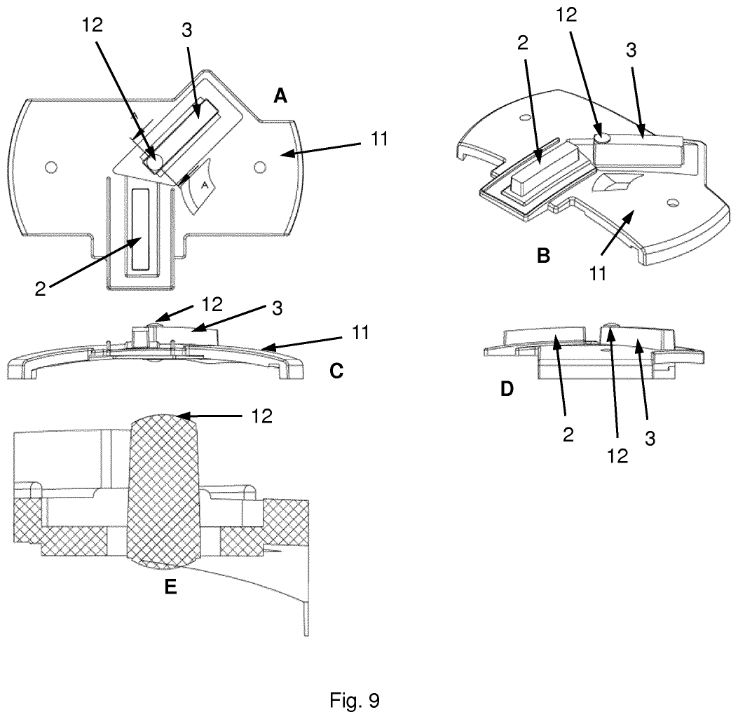

FIG. 9 A-E shows different views of another embodiment of the light guide 3. Again a support section 11 is shown. This embodiment of the light guide further comprises a circular light collecting region 12 on top the top surface of the light guide. This region may act as a lens gathering and more efficiently directing light to the light sensor below. It may furthermore collect and gather light uniformly from a wide range of directions, thereby mimicking the eye to a high degree of accuracy. In this embodiment, the circular light collecting region 12 is a biconvex lens.

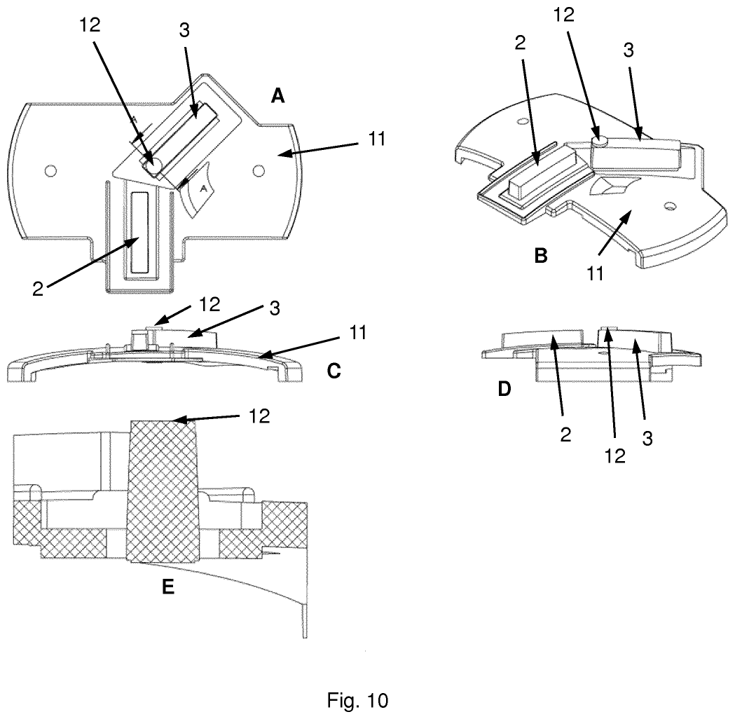

FIG. 10 A-E shows another embodiment of the light guide 3 with close resemblance to the one shown in FIG. 9. In this embodiment the circular light collecting region 12 is flat on the top and bottom. The measurement is subsequently cosine corrected to improve the resemblance to the human eye.

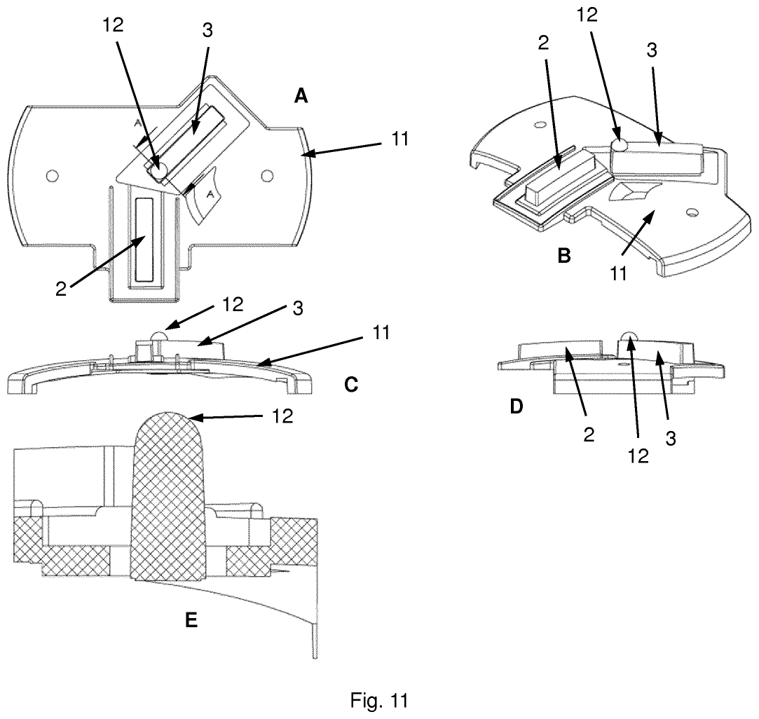

FIG. 11 A-E shows another embodiment of the light guide 3 with close resemblance to the one shown in FIG. 9. In this embodiment the circular light collecting region 12 is a hemispherical lens.

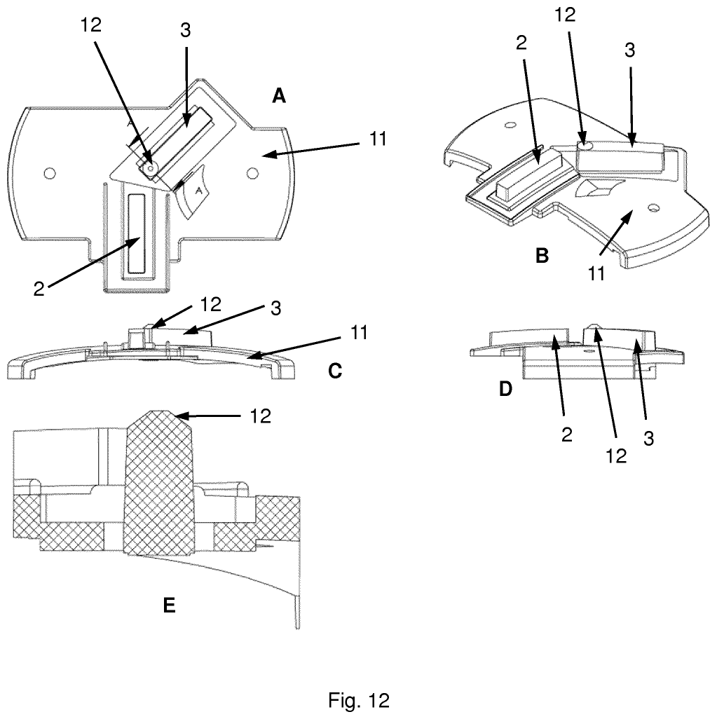

FIG. 12 A-E shows another embodiment of the light guide 3 with close resemblance to the one shown in FIG. 9. In this embodiment the circular light collecting region 12 is in the shape of a truncated cone.

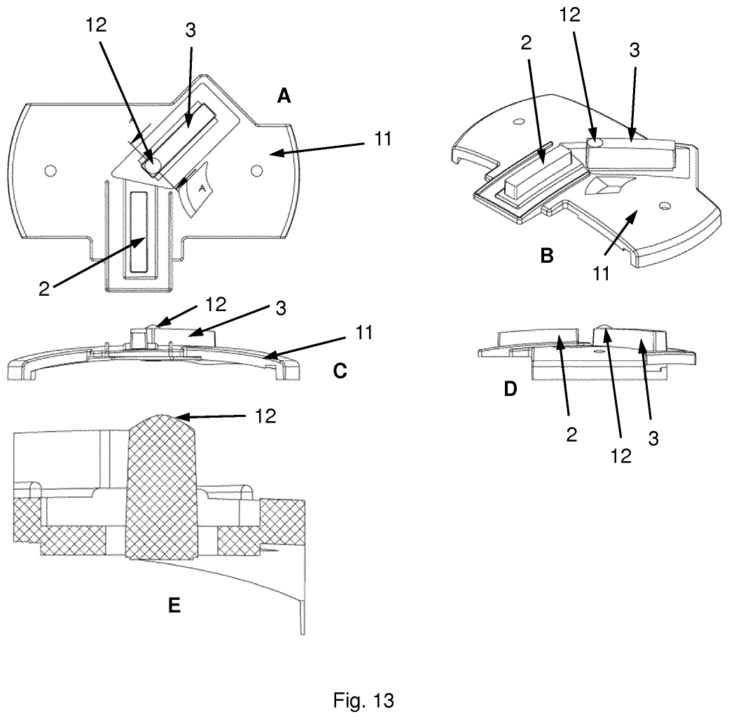

FIG. 13 A-E shows another embodiment of the light guide 3 with close resemblance to the one shown in FIG. 9. In this embodiment the circular light collecting region 12 is parabolic.

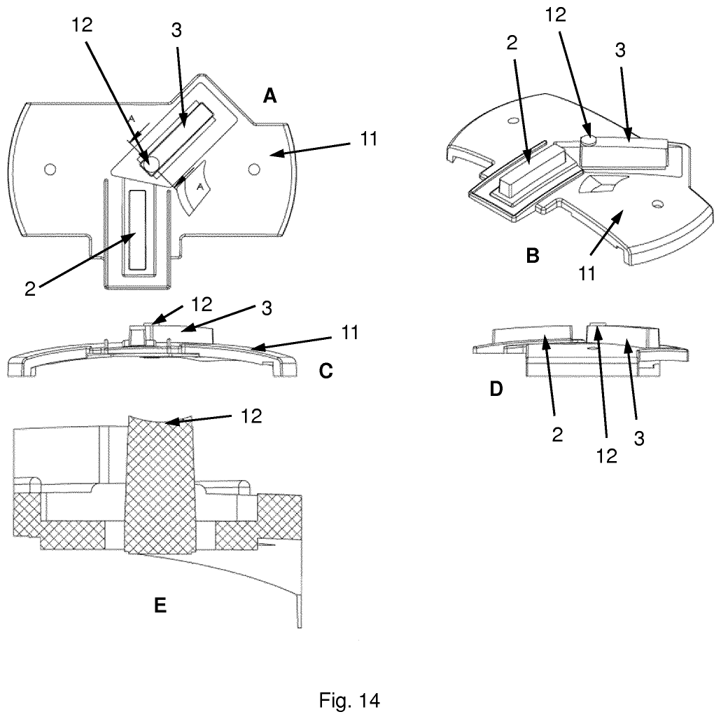

FIG. 14 A-E shows another embodiment of the light guide 3 with close resemblance to the one shown in FIG. 9. In this embodiment the circular light collecting region 12 is plano-concave.

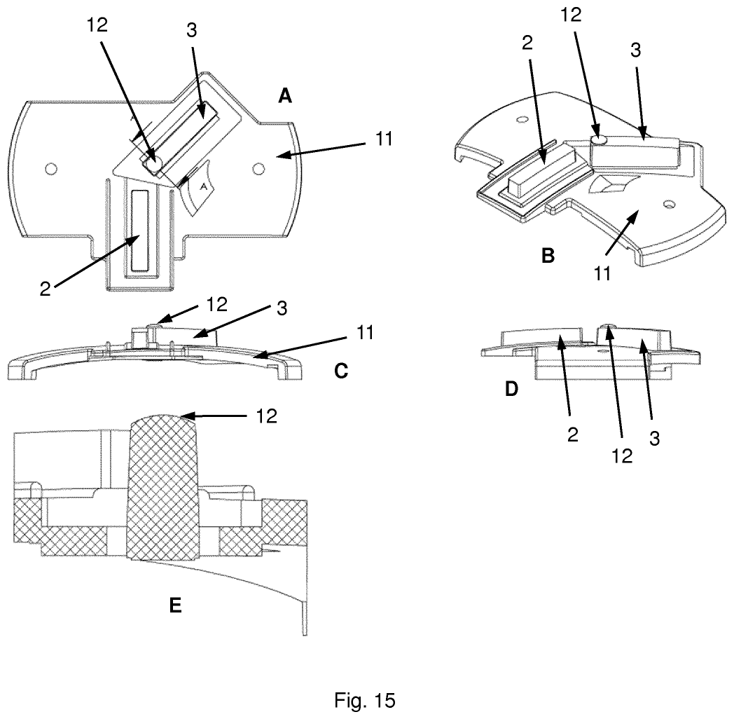

FIG. 15 A-E shows another embodiment of the light guide 3 with close resemblance to the one shown in FIG. 9. In this embodiment the circular light collecting region 12 is plano-convex.

FIG. 16 shows an embodiment of a slightly modified version of the light guide shown in FIGS. 5 and 6. Here, the support structure has been changed. The light guide of this embodiment may gather more light coming from above the horizon as for the one in FIGS. 5 and 6.

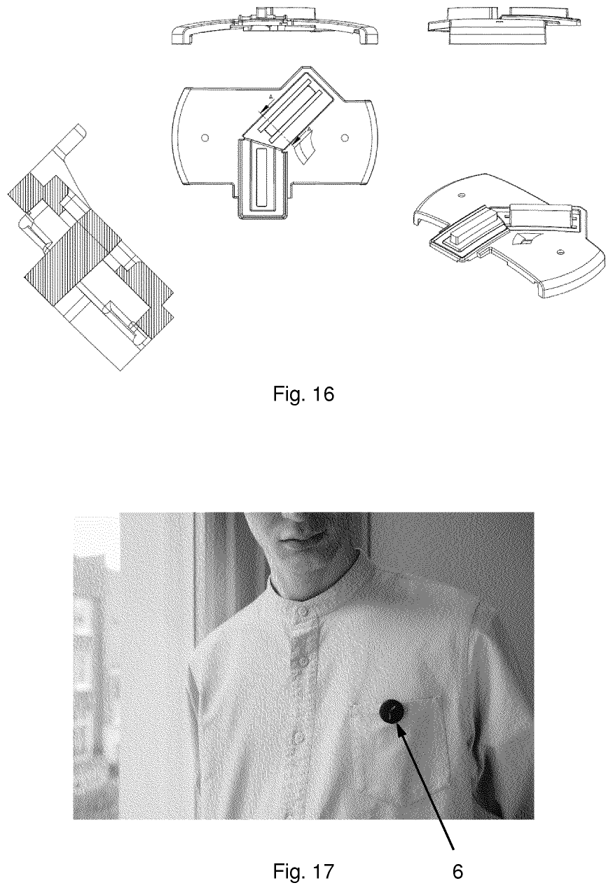

FIG. 17 shows another embodiment of the invention worn by a user, where the logo on the device 6 is different.

### FURTHER DETAILS OF THE PRESENT DISCLOSURE The present disclosure may be described by the following items:

1. A wearable device for measuring the light conditions of a subject, the device comprising:
   a light sensor for measuring said light conditions, and
   a light guide for collecting incoming light and directing it to said light sensor.
2. The device according to item 1, wherein the light guide is configured for collecting light from substantially all directions within a hemisphere with respect to the device and direct said light to the light sensor.
3. The device according to item 1, wherein the light guide is configured for collecting light from a predefined direction with respect to the device, said predefined direction defined by polar angles in the range between −90° and 90° and azimuth angles in the range between −30° and 90°
4. The device according to item 1, wherein the light guide is configured for collecting light from primarily one quadrant defined by polar angles in the range between −90° and 90° and azimuth angles in the range between 0° and 90°, and direct said light to the light sensor, or wherein the light guide is configured for collecting light from polar angles in the range between −60° and 60° and azimuth angles in the range between 0° and 60°, and direct said light to the light sensor.
5. The device according to item 4, wherein the quadrant is in front of the light guide towards the top of the device such that the quadrant is in front of a subject and above the horizon when worn by a subject.
6. The device according to any of the preceding items, wherein at least part of the outer surface of the light guide exposed to the incoming light is planar, or spherical or forms part of a sphere, or ellipsoidal or forms part of an ellipsoid, or a polyhedron or forms part of a polyhedron, or paraboloidal, or a plurality of planar faces, or cylindrical, or conical, or in the shape of a prism, or any combination thereof.
7. The device according to any of the preceding items, wherein at least part of the light guide is shaped as a rectangular prism or a rectangular prism with one face forming a skew angle with at least one of the other faces.
8. The device according to any of the preceding items, wherein the size of the light-gathering part of the light guide along its longest direction is less than 20 mm, or less than 15 mm, or less than 10 mm, or less than 7 mm, or less than 5 mm.
9. The device according to any of the preceding items, wherein the size of the light-gathering part of the light guide along its longest direction is at least 4 mm, or at least 6 mm, or at least 8 mm, or at least 10 mm, or at least 12 mm, or at least 16 mm, or at least 20 mm.
10. The device according to any of the preceding items, wherein the light guide is located on the outer surface of the device.
11. The device according to any of the preceding items, further comprising a housing and wherein the light guide is integrated into said housing such that at least part of the light guide is protruding through the surface of said housing.
12. The device according to any of the preceding items, wherein the light guide is shaped like a circle, or an ellipse, or a ring, or a triangle, or a square or any other polygon, or shaped like one or more letters or a part of one or more letters, or one or more recognizable symbols, or shaped like a logo, or an image or any combination thereof.
13. The device according to item 12, wherein said symbol(s) or letter(s) protrude from the surface of the device.
14. The device according to any of the preceding items, wherein the light guide is constructed such that it constitutes at least part of a logo shaped as “LYS”.
15. The device according to item 14, wherein the light guide constitutes at least part of the “Y”, such as the lower straight portion or one of the upper straight portions.
16. The device according to any of the preceding items, wherein the light guide is made from a plastic material such as acrylic glass (PMMA).
17. The device according to any of the preceding items, wherein the surface of the light guide is rough or uneven or textured.
18. The device according to any of the preceding items, wherein the sensor is configured for measuring the intensity and/or illuminance and/or color temperature of the light.
19. The device according to any of the preceding items, wherein the sensor is configured for measuring the light intensity of blue light.
20. The device according to any of the preceding items, wherein the sensor is configured for measuring light with wavelengths in the range 420-490 nm or in the range 440-470 nm.
21. The device according to any of the preceding items, wherein the sensor is configured for measuring the light intensity for selected spectral regions, such as red, green and blue.
22. The device according to any of the preceding items, wherein the sensor is configured for measuring the light intensity for wavelengths in the visible spectrum.
23. The device according to any of the preceding items, wherein the device is part of or attachable to an earring, a clip, a brooch, bracelet, a necklace, a ring, a watch, a belt buckle, a spectacle glass or spectacle frame.
24. The device according to any of the preceding items, further comprising a fastening element, such as a clip or a pin or a safety pin, for attaching the device to the clothes of the subject, such as a shirt, a collar, a pocket, a belt, a hat or other headgear, a shoe, a pair of pants, a jacket, a headband or sweatband, or for attaching the device to a bag or a backpack, or a strap of a bag or a backpack.
25. The device according to any of the preceding items, further comprising a power source for powering the device.
26. The device according to item 25, wherein the power source comprises a battery.
27. The device according to any of the preceding items, further comprising a computer readable medium for storing said measured light conditions.
28. The device according to any of the preceding items, further comprising a wireless communication module for communicating wirelessly with another device, such as a phone.
29. The device according to item 28, wherein the wireless communication module is a Bluetooth module.
30. The device according to any of the preceding items, wherein the device is configured for measuring the light conditions at regular intervals, such as every 5 minutes, or every 2 minutes, or every 1 minute, or every 30 seconds, or every 20 seconds, or every 15 seconds, or every 10 seconds, or every 5 seconds.
31. The device according to any of the preceding items, further comprising an accelerometer for measuring the activity of the subject.
32. The device according to any of the preceding items, further comprising a software application executable on a remote device and configured for
   receiving data from the device via a receiver on the remote device,
   processing said data by means of the remote device to provide data representing the light exposure of the subject wearing the device, and
   displaying at least a part of said data on a screen of the remote device.
33. The device according to item 32, wherein the software application is further configured for receiving inputs characterizing the subject, such as age, gender and chronotype.
34. The device according to any of items 32 to 33, wherein the software application is further configured for displaying a now-function showing and/or analyzing the light exposure in real-time and/or a day-function showing and/or analyzing the light exposure throughout one day and/or a week-function showing and/or analyzing the light exposure during a week.
35. The device according to any of items 32 to 34, wherein the software application is further configured for comparing said data to a predefined range and notifying the user when light levels are outside said predefined range.
36. The device according to any of items 32 to 35, wherein the software application is further configured for receiving input from the user indicating emotional or physical feeling such as mood and/or energy level and/or tiredness.
37. The device according to any of the preceding items, wherein the device is configured for communicating with a vehicle such that the lighting in the vehicle may be adjusted according to the measurements from the device and/or the characteristics of the subject, such as age, gender and chronotype, and/or the need of the subject wearing the device.

1. A wearable device for estimating the light conditions of a subject wearing the device, the device comprising:
a top surface,
a light sensor located below the top surface for measuring said light conditions, and
a light guide protruding through the top surface of the device for collecting incoming light and directing it to said light sensor,
wherein the light guide comprises at least a transparent piece of material with a circularly shaped light collecting region located substantially above the light sensor.

2. The device according to claim 1, wherein the light guide is configured for collecting light from primarily one quadrant defined by polar angles in the range between −90° and 90° and azimuth angles in the range between 0′ and 90′, and direct said light to the light sensor, or wherein the light guide is configured for collecting light from polar angles in the range between −60′ and 60° and azimuth angles in the range between 0° and 60°, and direct said light to the light sensor.

3. The device according to claim 1, wherein the outer surface of the light guide exposed to the incoming light is planar or forms at least part of a sphere.

4. The device according to claim 1, wherein the size of the light-gathering part of the light guide along its longest direction is at least 8 mm, or at least 16 mm.

5. The device according to claim 1, further comprising a housing and wherein the light guide is integrated into said housing such that at least a part of the light guide is protruding through the surface of said housing.

6. The device according to claim 1, wherein the light guide is shaped like one or more recognizable symbols or letters or forms at least part of one or more recognizable symbols or letters located at the surface of the device.

7. The device according to claim 6, wherein said symbol(s) or letter(s) protrude from the surface of the device.

8. The device according to claim 1, wherein the sensor is configured for measuring the intensity and/or color temperature of the light.

9. The device according to claim 1, wherein the sensor is configured for measuring light with wavelengths in the range 440-470 nm.

10. The device according to claim 1, further comprising a fastening element configured for attaching the device to the clothes of the subject.

11. The device according to claim 1, wherein the device is configured for measuring the light conditions at regular intervals.

12. The device according to claim 1, further comprising a software application executable on a remote device and configured for:
receiving data from the device via a receiver on the remote device,
processing said data by means of the remote device to provide data representing the light exposure of the subject wearing the device, and
displaying at least a part of said data on a screen of the remote device.

13. The device according to claim 12, wherein the software application is further configured for receiving inputs characterizing the subject.

14. The device according to claim 12, wherein the software application is further configured for displaying a now-function showing and/or analyzing the light exposure in real-time and/or a day-function showing and/or analyzing the light exposure throughout one day.

15. The device according to claim 12, wherein the software application is further configured for comparing said data to a predefined range and notifying the user when light levels are outside said predefined range.

16. The device according to claim 10, wherein the fastening element is in the form of a clip or pin.

17. The device according to claim 1, wherein the device is configured for measuring the light conditions at regular intervals every 5 minutes or every 1 minute.

18. The device according to claim 13, wherein the inputs characterizing the subject are selected from the group of age, gender and chronotype.
